(19) United States
(12) Patent Application Publication
(10) Pub. No.: US 2009/0063406 A1
(43) Pub. Date: Mar. 5, 2009

(54) Method, Service and Search System for Network Resource Address Repair

(76) Inventors: Amit Golander, Tel-Aviv (IL); Onn Menahem Shehory, Neve-Monosson (IL)

Correspondence Address: IBM CORPORATION, T.J. WATSON RESEARCH CENTER, P.O. BOX 218, YORKTOWN HEIGHTS, NY, 10598, US

(21) Appl. No.: 11/845,093

(22) Filed: Aug. 27, 2007

(51) Int. Cl. G06F 17/30

(52) U.S. Cl. 707/3; 707/E17.108

(57) ABSTRACT

A method, service and search system for network resource address repair are provided. The method which may be provided as a service over a network, includes: receiving a network resource address that is incorrect; dividing the network resource address into a host address and a path within the host address; searching for the host address, and repairing the host address if an error is found; and, if the host address if found or repaired, searching for the path. A search system is provided which includes a means for activating a network resource address repair if a network resource address is incorrect; and a means for repairing a network resource address. The means for repairing a network resource address includes inputting the host address or the path separately into the query processing means of the search engine.

### FIELD OF THE INVENTION

This invention relates to the field of network resource address repair. In particular, the invention relates to network resource address repair for network resource addresses used by a search engine.

### BACKGROUND OF THE INVENTION

Network resource addresses identify the location of web resources. The most common form of network resource address is a uniform resource locator (URL) (also known as a uniform resource identifier (URI). URLs are referred to throughout this document; however, it should be appreciated that other forms of network resource address could be substituted for a URL, for example, such as extensible resource identifiers (XRI) and internationalized resource identifiers (IRI).

Hyperlinks use URLs to locate web resources, as a URL points at an address of web content. URLs provide an important method for information search on the web, both manual and automated. The URL address may comprise several elements. FIG. 1 shows a URL address 100 with component parts. The address 100 includes a protocol 101 (also referred to as a scheme name) and a host 103 (also referred to as a domain name). The address 100 may also include some or all of the components of: a login 102, a port 104, a path 105, a query 106, and an anchor/fragment 107. In the common usage, two main elements are used after the protocol 101: a host 103; and a path 104 in that host's directory.

Unfortunately, in many cases URLs are incorrect or may become incorrect over time. Errors in URLs may result from multiple sources and can be generated at different phases of the URL lifecycle. For example, errors in URLs include typos at the creation of the URL and changes that occur over time in the actual location of content pointed at by the URL. The changes that occur over time may result from changes in the host name or changes in the path, and may be especially frequent when the content resides at a cache server.

To prevent a search from failing because of such URL errors which result in broken links, it is necessary to repair them.

Current solutions allow the client/server to repair some broken URLs on their own at runtime when a broken link is encountered. However, no such solution is available for broken links encountered by search engines.

Search engines allow the user to insert a URL in the query field. In the case of an error in the URL, the search will fail or will return irrelevant results. This will be the case, for example, if instead of “www.cs.biu.ac.il” a user places “www.cs.bix.ac.il” in a search engine's query field.

### SUMMARY OF THE INVENTION

According to a first aspect of the present invention there is provided a method for repairing a network resource address used by a search engine, comprising: receiving a network resource address that is incorrect; dividing the network resource address into a host address and a path within the host address; searching for the host address, and repairing the host address if an error is found; if the host address is found or repaired, searching for the path.

According to a second aspect of the present invention there is provided a computer program product stored on a computer readable storage medium for repairing a network resource address used by a search engine, comprising computer readable program code means for performing the steps of: receiving a network resource address that is incorrect; dividing the network resource address into a host address and a path within the host address; searching for the host address, and repairing the host address if an error is found; if the host address is found or repaired, searching for the path.

According to a third aspect of the present invention there is provided a method of providing a service to a customer over a network to repair a network resource address, the service comprising: receiving a network resource address that is incorrect; dividing the network resource address into a host address and a path within the host address; searching for the host address, and repairing the host address if an error is found; if the host address is found or repaired, searching for the path.

According to a fourth aspect of the present invention there is provided a search system comprising: a search engine including a crawler means, and a query processing means; a database indexing the searchable resources, each identified by a network resource address; a means for activating a network resource address repair if a network resource address is incorrect; and a means for repairing a network resource address.

An automated method for fixing URL errors within search engines is provided. The advantages are as follows:

1. Online repair of a URL in the user's query will improve search results for that user. While a client/server has to approach DNS (domain name system) servers to repair a URL, a search engine has most of the content of the web on disk.
2. The results of a repair can be recorded for future searches to improve the general quality of search results for all users.
3. Repairs can be generated offline as part of the crawling process. As a result, both timeliness and accuracy of search results improve.

In the case of a successful repair process, the user will either see a corrected URL without noticing that anything went wrong, or will be provided with an error message that also suggests a list of possible alternative links or extra analysis.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a diagram of a network resource address with its component parts as known in the art;

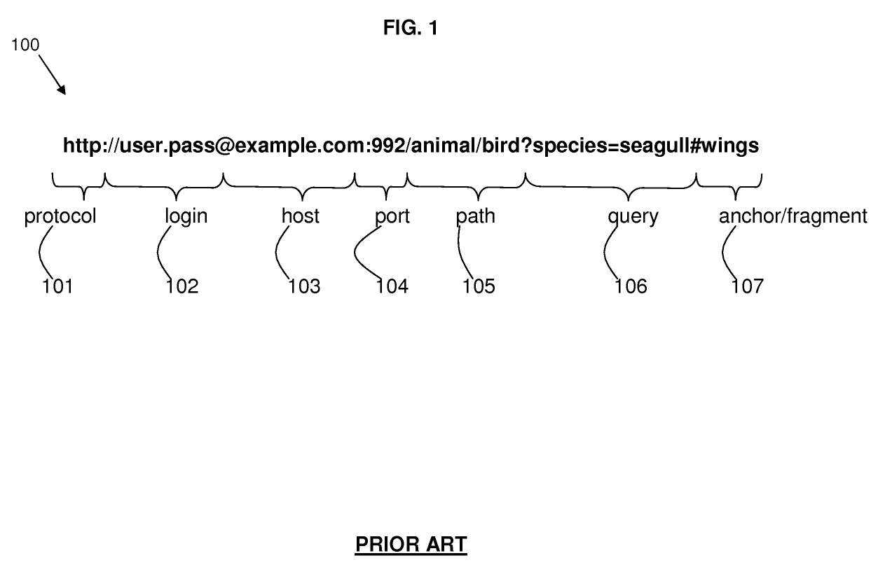

FIG. 2 is a block diagram of a system in accordance with the present invention;

FIG. 3 is a block diagram of a computer system in which the present invention may be implemented;

FIG. 4 is a flow diagram of a method in accordance with a first aspect of the present invention; and

FIG. 5 is a flow diagram of a method in accordance with a second aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

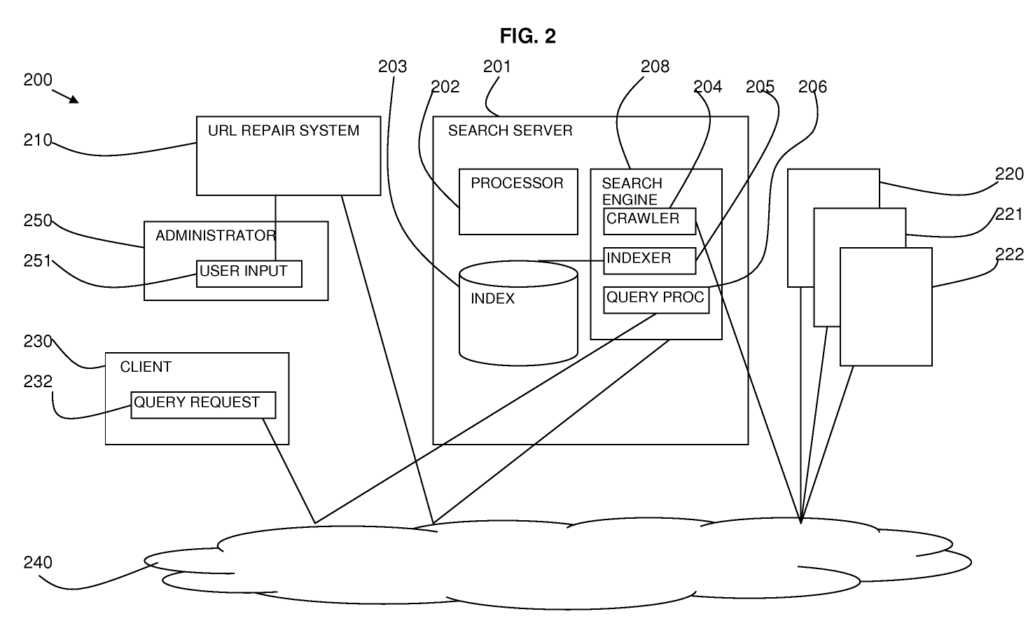

Referring to FIG. 2, a block diagram of a search system 200 is shown including a network resource address repair system (herein after referred to as a URL repair system) 210 in accordance with the present invention.

A search server 201 is provided including a central processing unit (CPU) 202 and a database 203. The search server 201 provides a search engine 208 including: a crawler application 204 for gathering information from servers 220, 221, 222 via a network 240; an application 205 for creating an index or catalogue of the gathered information in the database 203; and a search query application 206. The index stored in the database 203 references URLs of documents or other resources in the servers 220, 221, 222 with information extracted from the documents.

The search query application 206 receives a query request 232 from a client 230 via the network 240, compares it to the entries in the index stored in the database 203 and returns the results in mark-up language pages or links. When the client 230 selects a link to a document, the client's browser application is routed straight to the server 220, 221, 22 which hosts the document.

The URL repair system 210 may be integral with or coupled to the search server 201 or in communication with the search server 201 via a network 240 (as shown). The URL repair system 210 may be provided as a web service over a network 240.

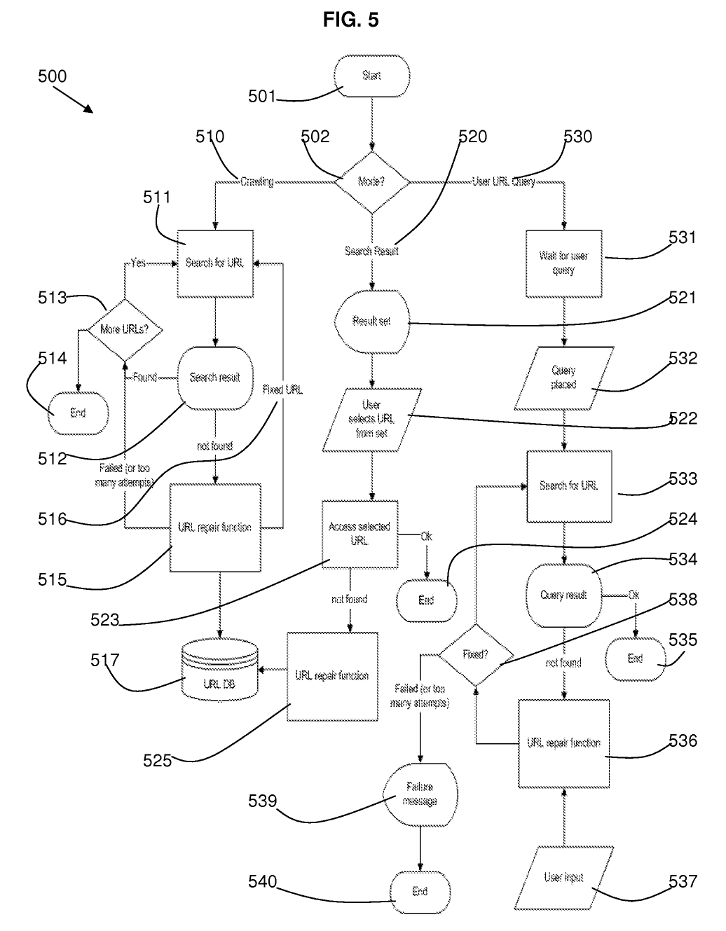

The URL repair system 210 includes a means for running a URL repair process for URLs used by or input into the search engine 208 which are incorrect and do not link to the required network resource. Further details of the URL repair function are provided with reference to FIG. 5.

A search engine 208 will call the URL repair system 210 to repair a URL in various different scenarios. Firstly, while the search engine 208 is crawling the web it validates new and modified URLs. A URL that does not exist will have the URL repair process applied. Secondly, a query request 232 from a client may include a URL which is incorrect and the URL repair process can be called. In other words, a user search text may be a URL which is incorrect. Thirdly, a URL may be accessed from a search result and a link may be broken. Again, the URL repair process is applied. Repaired URLs can also be updated in the search engine database 203.

Optionally, an administrator 250 may be provided with access to the URL repair system 210 either directly (as shown) or via a network 240. The administrator 250 includes a user input means 251 for assisting choices in the URL repair process.

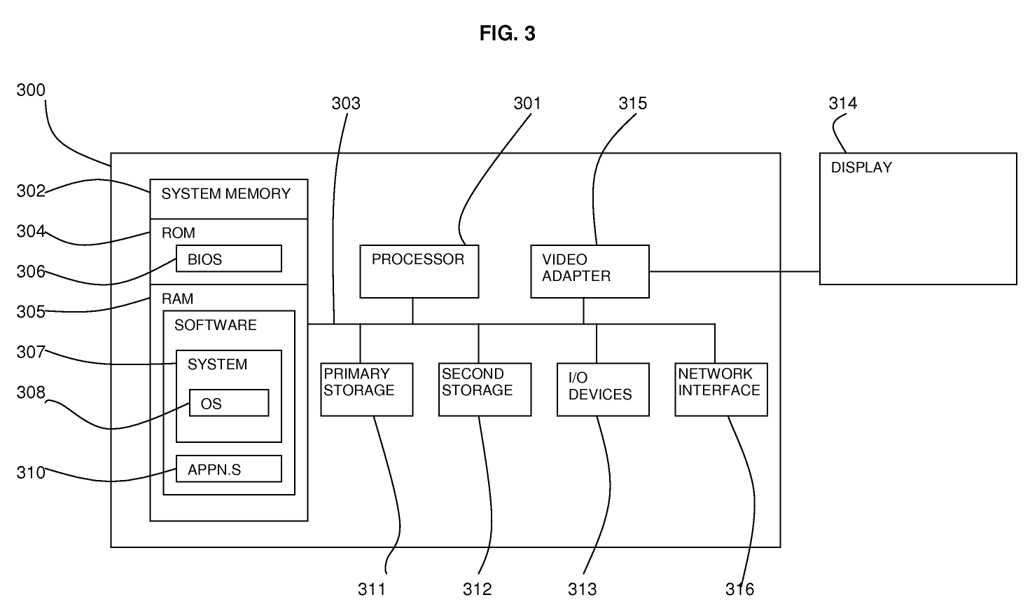

Referring to FIG. 3, an exemplary system for implementing the search server 201, a server supporting the URL repair system 210, or a client system 230. The exemplary system includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices. Output devices may include speakers, printers, etc. A display device 314 is also connected to system bus 303 via an interface, such as video adapter 315.

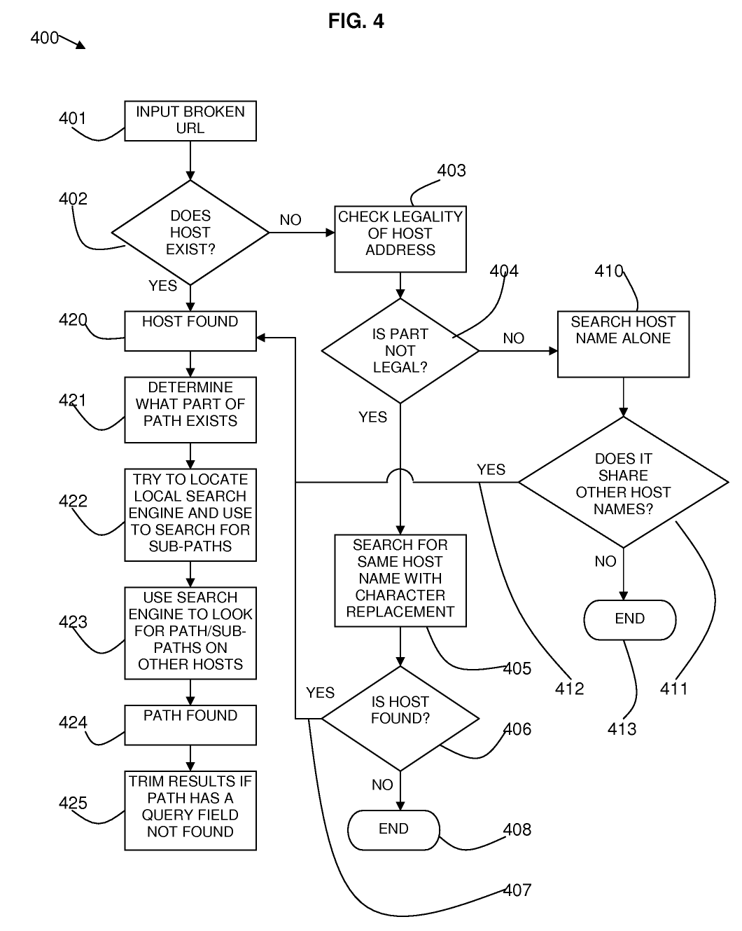

Referring to FIG. 4, a flow diagram 400 of a URL repair process, also referred to as a URL repair function, is shown. The process includes three stages:
the first stage consists of finding/fixing the host address;
the second stage consists of finding/analyzing the path; and
the third stage consists of handling the query and fragment fields.

The broken URL is input 401. It is determined 402 if the host address exists. If it does not exist, the legality of the host address is checked 403. It is determined 404 if part of the address is not legal (for example, a country abbreviation that does not exist). If part of the address is not legal, a search is carried out 405 for the host name with character replacements (for typographical errors, etc.). It is determined 406 if the host is found and, if so, the process proceeds 407 to the second stage to search the path for the host. If not, the process ends 408.

If the host address is legal, a search 410 for the host name alone is carried out using the search engine. Only a second field of a host name may also be searched, or a first and second field, if the first field is not “www”, for example, in http://harrypotter.warnerbros.co.uk “harrypotter”, “warnerbros” and/or “harrypotter.warnerbros” may be searched.

It is determined 411 from the search results, whether the URLs provided share other host names. If such shared host names are found, the process proceeds 412 to the second stage to search the path for these hosts. If the host does not share other host names, the process ends 413.

If the host is found 420, the second stage of the process is carried out to find the path. For example, assume the URL path is aaa/bbb/ccc/ddd. It is determined 421 what part of the path exists, and what part is erroneous. For example, does aaa/bbb/ccc exist? If not, does aaa/bbb exist etc.

The process then tries to locate 422 a local search engine for the host (for example, http://www.cityofboston.gov/search, http://www.sandiegozoo.org/search, www.tau.ac.il/search-eng.html) to use it to search for sub-paths (ddd, ccc/ddd etc.).

A search engine is used to look 423 for the path on other hosts. This is particularly applicable if the host is a cache server. This step could also be refined to sub-paths if they are long or could be broken into dictionary words (e.g. bbb=“supercomputing”).

The path results are returned 424. If the host and path are found, but the URL has a query field which is not found, the web resource pointed to by the trimmed URL is returned 425, that does not contain the query and fragment fields.

The function can produce none, a single or multiple suggestions for correction. In the case of multiple values, a human input (either the user and/or administrator) can assist in choosing the correct repair either online or offline. In some cases, artificial intelligence methods could be applied as well.

User or administrator input can be made into the process shown in FIG. 4 to aid the repair process, mainly by choosing the best repair if several options exist.

A search engine will try to repair a URL on the following events:

1. Offline crawling. While crawling the web, the search engine validates new and modified URLs (or all URL if time permits). A URL that does not exist goes through the URL repair process, and is not cached in its un-repaired form in order to avoid search engine database contamination.

2. User URL query. Experiments show that current search engines have trouble finding either:

a) complex though correct URLs, that include a query+anchor/fragment fields (for example, http://www.google.co.il/search?h1=iw&q=http%3A%2F%2Fwww.p 1000.co.il%2Fhot_sale_cat.asp%3Fcat_id%3D193%26d_link%3DCat_%D7%90%D7%91% D7%99% D7%96%D7% A8% D7%99%2520% D7%A8%D7%9B%D7%91&meta=); or

b) URLs with errors (for example, “http://eslab.tau.ac.il/peoble.html” instead of “http://eslab.tau.ac.il/people.html”). The URL repair process is called in case of a broken URL query.

3. Accessing a URL from the search result. After receiving the search results, a user can try and access a returned URL, which might be broken. In such a case the search engine will activate the URL repair process. Repaired URLs will also be updated in the search engine database, for the benefit of others.

It should be noted that the three uses are not identical, as the presence of a human can assist the repair process, mainly by choosing the best repair if several options exist. Enabling feedback to the search engine database when a human assists depends on search engine perception as it involves trust issues and an ability to dedicate employees to monitor it.

FIG. 5 shows a flow diagram 500 of processes in which the URL repair function of FIG. 4 is applied. The process starts 501 and the mode is determined 502, as one of crawling 510, search query 520, or user URL query 530.

In the crawling mode 510, a search is made 511 for a URL and the search result returned 512. If the URL is found, it is determined 513 if there are more URLs and, if so, the process loops to search for the next URL 511, otherwise the process ends 514. If the URL is not found, the URL repair function is applied 515.

If the URL repair function is successful, the repaired URL 516 is searched 511. The repaired URL is saved 517 to the URL database. If the repair fails, or there are too many attempts, the process proceeds to the next URL 513, if available.

In the search result mode 520, a result set is returned 521 and a user selects 522 a URL from the set. The selected URL is accessed 523. If the access is successful, the URL is correct and the process ends 524. If the access is unsuccessful and the URL is not found, the URL repair function 525 is applied and a repaired URL is saved 517 to the URL database.

In the user URL query mode 530, the process waits 531 for a user query until a query is placed 532. A search is carried out 533 for the URL and the query results 534 are returned. If the query result is successful, the process ends 535. If the URL of the query is not found, the URL repair function 536 is applied. User input may be received 537 to assist the repair function. It is then determined 538 if the URL is repaired. If so, the repaired URL is searched 533, otherwise, a failure message is displayed 539 and the process ends 540.

A broken or incorrect link which cannot be repaired may be removed from a result page or could be returned but rated lower as an incorrect link.

A URL repair process alone or as part of a search system may be provided as a service to a customer over a network. For example, as a web service.

The described method, service and system can be used by:
Producers of software, specifically search tools and engines, web browsers, and web authoring tools;
Providers of services including search and web authoring; and
Any other business or individual that needs improved web search and browsing.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for repairing a network resource address used by a search engine, comprising:
receiving a network resource address that is incorrect;
dividing the network resource address into a host address and a path within the host address;
searching for the host address, and repairing the host address if an error is found;
if the host address is found or repaired, searching for the path.

2. The method as claimed in claim 1, wherein searching for the host address determines if the host address is legal and, if not, searching for the host address with character replacements.

3. The method as claimed in claim 1, wherein searching for the host address includes searching for a host name in the host address alone using a search engine and determining if the host name shares other host addresses.

4. The method as claimed in claim 1, wherein searching for the path includes determining if a part of the path exists and if a portion of the path is incorrect.

5. The method as claimed in claim 1, wherein searching for the path includes locating a local search engine at the host address and using the local search engine to search for the path or portions of the path.

6. The method as claimed in claim 1, wherein searching for the path includes using a search engine to search for the path or portions of the path on other host addresses.

7. The method as claimed in claim 1, wherein the network resource address also includes a sub-field within the path, and if the host address and path are found but the sub-field is not found, returning results for the host address and path without the sub-field.

8. The method as claimed in claim 1, wherein the network resource address that is incorrect is located during crawling of the web by a search engine.

9. The method as claimed in claim 1, wherein the network resource address that is incorrect is input as a user search query into a search engine.

10. The method as claimed in claim 1, wherein the network resource address that is incorrect is returned in a search result.

11. The method as claimed in claim 1, including updating a search engine database with the repaired network resource address.

12. The method as claimed in claim 1, including user or administrator input to assist the search and repair of the host address and path.

13. A computer program product stored on a computer readable storage medium for repairing a network resource address used by a search engine, comprising computer readable program code means for performing the steps of:
receiving a network resource address that is incorrect;
dividing the network resource address into a host address and a path within the host address;
searching for the host address, and repairing the host address if an error is found;
if the host address is found or repaired, searching for the path.

14. A method of providing a service to a customer over a network to repair a network resource address, the service comprising:
receiving a network resource address that is incorrect;
dividing the network resource address into a host address and a path within the host address;
searching for the host address, and repairing the host address if an error is found;
if the host address is found or repaired, searching for the path.

15. A search system comprising:
a search engine including a crawler means, and a query processing means;
a database indexing the searchable resources, each identified by a network resource address;
a means for activating a network resource address repair if a network resource address is incorrect; and
a means for repairing a network resource address.

16. The search system as claimed in claim 15, wherein the means for repairing a network resource address includes:
means for dividing the network resource address into a host address and a path within the host address;
means for inputting the host address or the path separately into the query processing means of the search engine;
means for repairing the host address or path, if an error is found.

17. The search system as claimed in claim 15, wherein the means for activating the network resource address repair is called by the crawler means if a network resource address is located which is incorrect.

18. The search system as claimed in claim 15, wherein the means for activating the network resource address repair is called by the query processing means when a query includes an incorrect network resource address.

19. The search system as claimed in claim 15, wherein the means for activating the network resource address repair is called by the search engine if a search result includes an incorrect network resource address.
